(19) United States
(12) Patent Application Publication
(10) Pub. No.: US 2026/0127968 A1
(43) Pub. Date: May 7, 2026

(54) SYSTEMS AND METHODS FOR VALIDATING AIR TRAFFIC CONTROL MESSAGES

(71) Applicant: HONEYWELL INTERNATIONAL INC., Charlotte, NC (US)

(72) Inventors: Sivaraman Saptharishi, Bangalore (IN); Gobinathan Baladhandapani, Madurai (IN); Karthikeyan M, Madurai (IN)

(73) Assignee: HONEYWELL INTERNATIONAL INC., Charlotte, NC (US)

(21) Appl. No.: 19/010,482

(22) Filed: Jan. 6, 2025

(30) Foreign Application Priority Data
Nov. 5, 2024 (IN) 202411084618

(51) Int. Cl. G08G 5/26; G08G 5/72

(52) U.S. Cl. CPC G08G 5/26; G08G 5/727

(57) ABSTRACT

Systems and methods are provided for validating air traffic control (ATC) messages. A first ATC message including an ATC flight parameter is received from ATC via an ATC communication channel at a communication system of an aircraft. Dynamic data comprising a validation flight parameter is received from a dynamic data source via the communication system of the aircraft. A determination is made regarding whether the ATC flight parameter matches the validation flight parameter. A flight parameter mismatch indication associated with the first ATC flight parameter is generated for display on a display device of the aircraft based on the determination.

### CROSS REFERENCE TO RELATED APPLICATION

This application claims priority to India Provisional Patent Application No. 202411084618, filed Nov. 5, 2024, the entire content of which is incorporated by reference herein.

### TECHNICAL FIELD

The present invention generally relates to aircraft operations and more particularly relates to systems and methods for validating air traffic control messages.

### BACKGROUND

During the landing and take-off phases of flight of an aircraft, air traffic control (ATC) issues ATC clearance messages to the aircraft. The flight crew of the aircraft often have a relatively high workload during the landing and take-off phases of flight and rely on the ATC clearance messages to implement aircraft operations. Errors in the ATC clearance messages due to lapses in ATC message communications and situational misinterpretations based on incorrect assumptions and/or perceptions may lead to aircraft operation implementation errors by the flight crew.

Hence, there is a need for systems and methods for validating air traffic control messages.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

An air traffic control (ATC) validation system including at least one processor and at least one memory communicatively coupled to the at least one processor. The at least one memory includes instructions that, upon execution by the at least one processor, cause the at least one processor to: receive a first ATC message including a first ATC flight parameter from ATC via an ATC communication channel at a communication system of an aircraft; receive first dynamic data including a first validation flight parameter from a dynamic data source via the communication system of the aircraft; determine whether the first ATC flight parameter matches the first validation flight parameter; and generate a flight parameter mismatch indication associated with the first ATC flight parameter for display on a display device of the aircraft based on the determination.

A method of validating air traffic control (ATC) messages, including: receiving a first ATC message including a first ATC flight parameter from ATC via an ATC communication channel at a communication system of an aircraft; receiving first dynamic data including a first validation flight parameter from a dynamic data source via the communication system of the aircraft; determining whether the first ATC flight parameter matches the first validation flight parameter; and generating a flight parameter mismatch indication associated with the first ATC flight parameter for display on a display device of the aircraft based on the determination.

A non-transitory machine-readable storage medium that stores instructions executable by at least one processor, the instructions configurable to cause the at least one processor to perform operations including: receiving a first ATC message including a first ATC flight parameter from ATC via an ATC communication channel at a communication system of an aircraft; receiving first dynamic data including a first validation flight parameter from a dynamic data source via the communication system of the aircraft; determining whether the first ATC flight parameter matches the first validation flight parameter; and generating a flight parameter mismatch indication associated with the first ATC flight parameter for display on a display device of the aircraft based on the determination.

Furthermore, other desirable features and characteristics of the systems and methods for validating air traffic control messages will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 is a block diagram representation of a system configured to validate air traffic control (ATC) messages in accordance with least one embodiment;

FIG. 2 is a block diagram representation of a controller onboard an aircraft including an ATC message validation system in accordance with at least one embodiment;

FIG. 3 is a flowchart representation of a method of validating ATC messages in accordance with at least one embodiment; and

FIG. 4 is an exemplary ATC message validation display in accordance with at least one embodiment.

### DETAILED DESCRIPTION

The following detailed description is merely exemplary in nature. As used herein, the word “exemplary” means “serving as an example, instance, or illustration. ” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

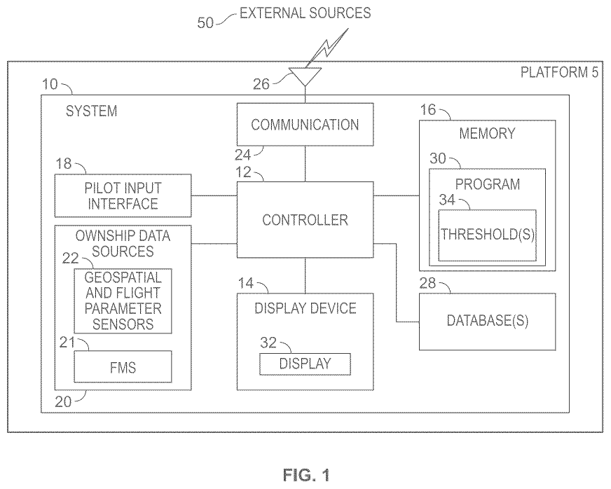

Referring to FIG. 1, a block diagram representation of a system 10 configured to validate air traffic control (ATC) messages in accordance with least one embodiment is shown. The system 10 may be utilized onboard a mobile platform 5, as described herein. In various embodiments, the mobile platform is an aircraft, which carries or is equipped with the system 10. As schematically depicted in FIG. 1, the system 10 may include one or more of the following components or subsystems, each of which may assume the form of a single device or multiple interconnected devices: a controller circuit 12 operationally coupled to: at least one display device 14; computer-readable storage media or memory 16; an optional input interface 18, and ownship data sources 20 including, for example, a flight management system (FMS) 21 and an array of flight system state and geospatial sensors 22.

In various embodiments, the system 10 may be separate from or integrated within: the flight management system (FMS) 21 and/or a flight control system (FCS). Although schematically illustrated in FIG. 1 as a single unit, the individual elements and components of the system 10 can be implemented in a distributed manner utilizing any practical number of physically distinct and operatively interconnected pieces of hardware or equipment. When the system 10 is utilized as described herein, the various components of the system 10 will typically all be located onboard the mobile platform 5.

The term “controller circuit” (and its simplification, “controller”), broadly encompasses those components utilized to carry-out or otherwise support the processing functionalities of the system 10. Accordingly, the controller circuit 12 can encompass or may be associated with a programmable logic array, application specific integrated circuit or other similar firmware, as well as any number of individual processors, flight control computers, navigational equipment pieces, computer-readable memories (including or in addition to the memory 16), power supplies, storage devices, interface cards, and other standardized components. In various embodiments, the controller circuit 12 embodies one or more processors operationally coupled to data storage having stored therein at least one firmware or software program (generally, computer-readable instructions that embody an algorithm) for carrying-out the various process tasks, calculations, and control/display functions described herein. During operation, the controller circuit 12 may be programmed with and execute the at least one firmware or software program, for example, a program 30, that embodies an algorithm described herein for validating air traffic control (ATC) messages in accordance with least one embodiment on a mobile platform 5, where the mobile platform 5 is an aircraft, and to accordingly perform the various process steps, tasks, calculations, and control/display functions described herein.

The controller circuit 12 may exchange data, including real-time wireless data, with one or more external sources 50 to support operation of the system 10 in embodiments. In this case, bidirectional wireless data exchange may occur over a communications network, such as a public or private network implemented in accordance with Transmission Control Protocol/Internet Protocol architectures or other conventional protocol standards. Encryption and mutual authentication techniques may be applied, as appropriate, to ensure data security.

The memory 16 is a data storage that can encompass any number and type of storage media suitable for storing computer-readable code or instructions, such as the aforementioned software program 30, as well as other data generally supporting the operation of the system 10. The memory 16 may also store one or more threshold 34 values, for use by an algorithm embodied in software program 30. One or more database(s) 28 are another form of storage media; they may be integrated with memory 16 or separate from it.

In various embodiments, aircraft-specific parameters and information for an aircraft may be stored in the memory 16 or in a database 28 and referenced by the program 30. Non-limiting examples of aircraft-specific information includes an aircraft weight and dimensions, performance capabilities, configuration options, and the like.

Flight parameter sensors and geospatial sensors 22 supply various types of data or measurements to the controller circuit 12 during an aircraft flight. In various embodiments, the geospatial sensors 22 supply, without limitation, one or more of: inertial reference system measurements providing a location, Flight Path Angle (FPA) measurements, airspeed data, groundspeed data (including groundspeed direction), vertical speed data, vertical acceleration data, altitude data, attitude data including pitch data and roll measurements, yaw data, heading information, sensed atmospheric conditions data (including wind speed and direction data), flight path data, flight track data, radar altitude data, and geometric altitude data.

With continued reference to FIG. 1, the display device 14 can include any number and type of image generating devices on which one or more avionic displays 32 may be produced. When the system 10 is utilized for a manned aircraft, the display device 14 may be affixed to the static structure of the Aircraft cockpit as, for example, a Head Down Display (HDD) or Head Up Display (HUD) unit. In various embodiments, the display device 14 may assume the form of a movable display device (e.g., a pilot-worn display device) or a portable display device, such as an Electronic Flight Bag (EFB), a laptop, or a tablet computer carried into the aircraft cockpit by a pilot.

At least one avionic display 32 is generated on the display device 14 during operation of the system 10; the term “avionic display” is synonymous with the term “aircraft-related display” and “cockpit display” and encompasses displays generated in textual, graphical, cartographical, and other formats. The system 10 can generate various types of lateral and vertical avionic displays 32 on which map views and symbology, text annunciations, and other graphics pertaining to flight planning are presented for a pilot to view. The display device 14 is configured to continuously render at least a lateral display showing the aircraft at its current location within the map data. The avionic display 32 generated and controlled by the system 10 can include graphical user interface (GUI) objects and alphanumerical input displays of the type commonly presented on the screens of multifunction control display units (MCDUs), as well as Control Display Units (CDUs) generally. Specifically, embodiments of the avionic displays 32 include one or more two-dimensional (2D) avionic displays, such as a horizontal (i.e., lateral) navigation display or vertical navigation display (i.e., vertical situation display VSD); and/or on one or more three dimensional (3D) avionic displays, such as a Primary Flight Display (PFD) or an exocentric 3D avionic display.

In various embodiments, a human-machine interface is implemented as an integration of a pilot input interface 18 and a display device 14. In various embodiments, the display device 14 is a touch screen display. In various embodiments, the human-machine interface also includes a separate pilot input interface 18 (such as a keyboard, cursor control device, voice input device, or the like), generally operationally coupled to the display device 14. Via various display and graphics systems processes, the controller circuit 12 may command and control a touch screen display device 14 to generate a variety of graphical user interface (GUI) objects or elements described herein, including, for example, buttons, sliders, and the like, which are used to prompt a user to interact with the human-machine interface to provide user input; and for the controller circuit 12 to activate respective functions and provide user feedback, responsive to received user input at the GUI element.

In various embodiments, the system 10 may also include a dedicated communications circuit 24 configured to provide a real-time bidirectional wired and/or wireless data exchange for the controller 12 to communicate with the external sources 50 (including, each of: traffic, air traffic control (ATC), satellite weather sources, ground stations, and the like). In various embodiments, the communications circuit 24 may include a public or private network implemented in accordance with Transmission Control Protocol/Internet Protocol architectures and/or other conventional protocol standards. Encryption and mutual authentication techniques may be applied, as appropriate, to ensure data security. In some embodiments, the communications circuit 24 is integrated within the controller circuit 12, and in other embodiments, the communications circuit 24 is external to the controller circuit 12.

In certain embodiments of the system 10, the controller circuit 12 and the other components of the system 10 may be integrated within or cooperate with any number and type of systems commonly deployed onboard an aircraft including, for example, an FMS 21.

The disclosed algorithm is embodied in a hardware program or software program (e.g. program 30 in controller circuit 12) and configured to operate when the aircraft is in any phase of flight.

In various embodiments, the provided controller circuit 12, and therefore its program 30 may incorporate the programming instructions for: receiving an ATC message including an ATC flight parameter from ATC via an ATC communication channel at a communication system of an aircraft; receiving dynamic data including a validation flight parameter from a dynamic data source via the communication system of the aircraft; determining whether the ATC flight parameter matches the validation flight parameter; and generating a flight parameter mismatch indication associated with the ATC flight parameter for display on a display device of the aircraft based on the determination.

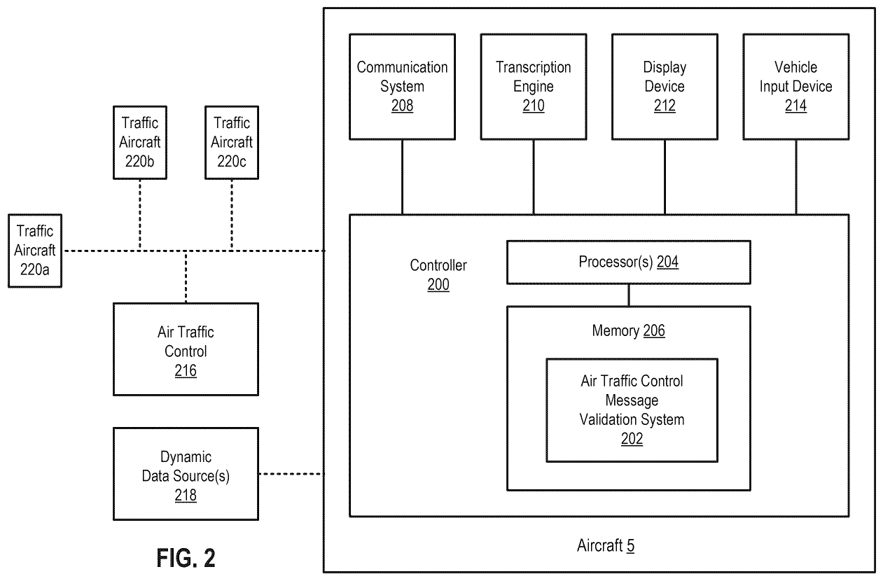

Referring to FIG. 2, a block diagram representation of a controller 200 onboard an aircraft 5 including an air traffic control (ATC) message validation system 202 in accordance with at least one embodiment is shown. The controller 200 includes at least one processor 204 and at least one memory 206. The controller 200 is similar to the controller circuit 12 described with reference to FIG. 1. The memory 206 is similar to the memory 16 described with reference to FIG. 1. The processor(s) 204 is communicatively coupled to the at least one memory 206. The processor(s) 204 is a programable device that includes one or more instructions stored in or associated with the at least one memory 206. The at least one memory 206 includes instructions that the processor(s) 204 is configured to execute. The at least one memory 206 includes the ATC message validation system 202.

The controller 200 is configured to be communicatively coupled to a communication system 208, a transcription engine 210, a display device 212, and a vehicle input device 214 of an aircraft 5. The communication system 208 is similar to the communication circuit 24 described with reference to FIG. 1. The display device 212 is similar to the display device 14 described with reference to FIG. 1. The vehicle input device 214 is similar to the pilot interface unit 18 described with reference to FIG. 1. While the transcription engine 210 is shown as a component that is separate from the ATC message validation system 202, in alternative embodiments, the transcription engine 210 may be a component of the ATC message validation system 202. In various embodiments, the controller 200 may include additional components that facilitate operation of the ATC message validation system 202.

The controller 200 is configured to be communicatively coupled to air traffic control (ATC) 216 at an airport via an ATC communication channel. The controller 200 is configured to be communicatively coupled to one or more dynamic data sources 218. Examples of dynamic data source include, but are not limited to, an Automatic Dependent Surveillance-Broadcast (ADS-B), a Traffic Alert and Collision Avoidance System (TCAS), a Notice to Airmen (NOTAM), radiotelephony (RTF), Controller Pilot Data Link Communications (CPDLC), an Internet-linked device, and an Automatic Terminal Information Service (ATIS).

The communication system 208 of aircraft 5 is tuned to the ATC communication channel when the aircraft 5 is preparing to land at or take-off from the airport. The aircraft 5 is configured to communicate with ATC 216 via the ATC communication channel. The communications between the aircraft 5 and ATC 216 are referred to as aircraft specific ATC messages. An example of an aircraft specific ATC message is an ATC clearance message in connection with the aircraft 5 landing at or taking-off from the airport. The ATC message validation system 202 is configured to receive the aircraft specific ATC messages.

ATC 216 is configured to transmit broadcast ATC messages that include content that is relevant to all aircraft within a vicinity of the airport via the ATC communication channel. The aircraft within the vicinity of the airport include the aircraft 5 and traffic aircraft 220a, 220b, 220c. The aircraft 5 and the traffic aircraft 220a, 220b, 220c are configured to receive the broadcast ATC messages via the ATC communication channel. The ATC message validation system 202 is configured to receive the broadcast ATC messages.

The communication systems of traffic aircraft 220a, 220b, 220c are tuned to the ATC communication channel when the traffic aircraft 220a, 220b, 220c are preparing to land at or take-off from the airport. The traffic aircraft 220a, 220b, 220c are configured to communicate with ATC 216 via the ATC communication channel. The communications between the traffic aircraft 220a, 220b, 220c and ATC 216 are referred to as traffic ATC messages. An example of a traffic ATC message is a traffic ATC clearance message in connection with the traffic aircraft 220a, 220b, 220c landing at or taking-off from the airport. Since the communication system 208 of the aircraft 5 is tuned to the ATC communication channel, the ATC message validation system 202 is configured to receive the traffic ATC messages at the communication system 208 of the aircraft 5 via the ATC communication channel. While three traffic aircraft 220a, 220b, 220c are shown, there may be a fewer or greater number of traffic aircraft in communication with ATC 216 at a given time.

The aircraft specific ATC messages received at the aircraft 5 via the ATC communication channel at the communication system 208 are aircraft specific ATC voice messages. The transcription engine 210 is configured to transcribe the aircraft specific ATC voice messages to generate aircraft specific ATC text messages. The broadcast ATC messages received at the aircraft 5 via the ATC communication channel at the communication system 208 are broadcast ATC voice messages. The transcription engine 210 is configured to transcribe the broadcast ATC voice messages to generate broadcast ATC text messages. The traffic ATC messages received at the aircraft 5 via the ATC communication channel at the communication system 208 are traffic ATC voice messages. The transcription engine 210 is configured to transcribe the traffic ATC voice messages to generate traffic ATC text messages. The ATC message validation system 202 is configured to receive the aircraft specific ATC text messages, the broadcast ATC text messages, and the traffic ATC text messages.

The aircraft specific ATC messages are addressed to the aircraft 5 and include ATC flight parameters associated with landing at or the taking-off from the airport. Examples of the ATC flight parameters include, but are not limited to, an aircraft landing parameter, an aircraft departure parameter, an aircraft traffic parameter, a ground traffic parameter, a runway identifier parameter, an assigned flight level parameter, a runway taxiway identifier parameter, a frequency parameter, a hold short point parameter, and a heading change parameter. The aircraft specific ATC messages include a time stamp.

The broadcast ATC messages are intended for the aircraft 5 and the traffic aircraft 220a, 220b, 220c. The broadcast ATC messages include ATC flight parameters. Examples of the ATC flight parameters include, but are not limited to, an external environment parameter and a mean pressure at sea level (QNH) parameter. The broadcast ATC messages include a time stamp.

The traffic ATC messages are addressed to the traffic aircraft 220a, 220b, 220c and include traffic flight parameters associated with the traffic aircraft 220a, 220b, 220c landing at and taking-off from the airport. The traffic flight parameters are used by the ATC message validation system 202 as validation flight parameters. Examples of the traffic flight parameters (also referred to as validation flight parameters) include, but are not limited to, an aircraft landing parameter, an aircraft departure parameter, an aircraft traffic parameter, a ground traffic parameter, a runway identifier parameter, an assigned flight level parameter, a runway taxiway identifier parameter, a frequency parameter, a hold short point parameter, and a heading change parameter. The traffic ATC messages include a time stamp.

The ATC message validation system 202 is configured to receive the ATC messages via the ATC communication channel at the communication system 208 of the aircraft 5. The received ATC messages include aircraft specific ATC messages and broadcast ATC messages. The ATC messages include ATC flight parameters. The ATC message validation system 202 is configured to extract the ATC flight parameters from the ATC messages.

In at least one embodiment, the ATC message validation system 202 is configured to receive dynamic data from one or more dynamic data sources 218 at the communication system 208 of the aircraft 5. The dynamic data includes dynamic data source generated flight parameters that the ATC message validation system 202 uses as validation flight parameters. The ATC message validation system 202 is configured to extract the validation flight parameters from the dynamic data. The ATC message validation system 202 is configured to determine whether the ATC flight parameters match the validation flight parameters. If the ATC message validation system 202 determines that at least one of the ATC flight parameters does not match a corresponding validation flight parameter, the ATC message validation system 202 is configured to generate a flight parameter mismatch indication for display on the display device 212 of the aircraft 5.

In at least one embodiment, the ATC message validation system 202 is configured to receive traffic ATC messages via the ATC communication channel at the communication system 208 of the aircraft 5. The ATC messages include traffic flight parameters. The ATC message validation system 202 is configured to use the traffic flight parameters as validation flight parameters. The ATC message validation system 202 is configured to extract the traffic flight parameters (also referred to as validation flight parameters) from the traffic ATC messages. The ATC message validation system 202 is configured to determine whether the ATC flight parameters match the validation flight parameters. If the ATC message validation system 202 determines that at least one of the ATC flight parameters does not match a corresponding validation flight parameter, the ATC message validation system 202 is configured to generate a flight parameter mismatch indication for display on the display device 212 of the aircraft 5.

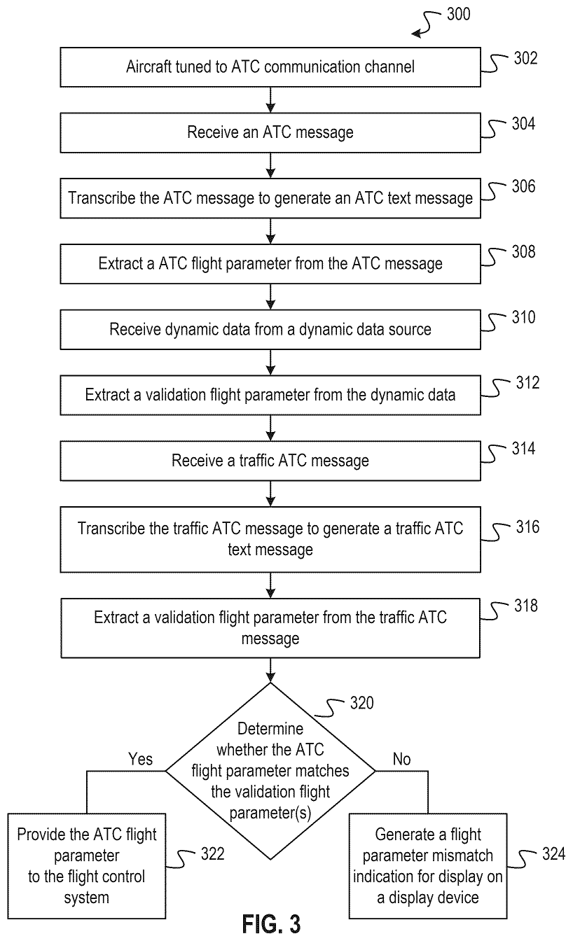

Referring to FIG. 3, a flowchart representation of a method 300 of validating ATC messages in accordance with at least one embodiment is shown. The method 300 will be described with reference to an exemplary implementation of an ATC message validation system 202. As can be appreciated in light of the disclosure, the order of operation within the method 300 is not limited to the sequential execution as illustrated in FIG. 3 but may be performed in one or more varying orders as applicable and in accordance with the present disclosure.

At 302, a communication system 208 of an aircraft 5 is tuned to an ATC communication channel. The ATC communication channel is a common communication channel used by the aircraft 5 and traffic aircraft 220a, 220b, 220c to communicate with ATC 216 at an airport. ATC 216 uses the ATC communication channel to transmit broadcast ATC messages. In at least one embodiment, the aircraft 5 is tuned to the ATC communication channel as the aircraft 5 approaches the airport in preparation for landing at the airport. In at least one embodiment, the aircraft 5 is tuned to the ATC communication channel as the aircraft 5 prepares for take-off from the airport.

At 304, the ATC message validation system 202 receives an ATC message from ATC 216 via the ATC communication channel at a communication system 208 of the aircraft 5. In at least one embodiment, the ATC message is an aircraft specific ATC message. In at least one embodiment, the ATC message is a broadcast ATC message. In at least one embodiment, the ATC message is an ATC clearance message associated with preparations for landing the aircraft 5 at the airport. In at least one embodiment, the ATC message is an ATC clearance message associated with preparations for the aircraft 5 to take-off from the airport.

At 306, the ATC message is transcribed to generate an ATC text message. The ATC message received at the aircraft 5 is an ATC voice message. A transcription engine 210 transcribes the ATC voice message to generate an ATC text message.

At 308, the ATC message validation system 202 extracts an ATC flight parameter from the ATC message. In at least one embodiment, the ATC message validation system 202 extracts the ATC flight parameter from the ATC text message.

In at least one embodiment, the ATC message is an aircraft specific ATC message. The aircraft specific ATC message is addressed to the aircraft 5 and includes ATC flight parameters associated with landing at or the taking-off from the airport. Examples of the ATC flight parameters include, but are not limited to, an aircraft landing parameter, an aircraft departure parameter, an aircraft traffic parameter, a ground traffic parameter, a runway identifier parameter, an assigned flight level parameter, a runway taxiway identifier parameter, a frequency parameter, a hold short point parameter, and a heading change parameter.

In at least one embodiment, the ATC message is a broadcast ATC message. The broadcast ATC message is intended for the aircraft 5 and traffic aircraft 220a, 220b, 220c. The broadcast ATC messages include ATC flight parameters. Examples of the ATC flight parameters include, but are not limited to, an external environment parameter and a mean pressure at sea level (QNH) parameter.

At 310, the ATC message validation system 202 receive dynamic data from a dynamic data source. Examples of dynamic data source include, but are not limited to, an Automatic Dependent Surveillance-Broadcast (ADS-B), a Traffic Alert and Collision Avoidance System (TCAS), a Notice to Airmen (NOTAM), radiotelephony (RTF), Controller Pilot Data Link Communications (CPDLC), an Internet-linked device, and an Automatic Terminal Information Service (ATIS).

At 312, the ATC message validation system 202 extracts a validation flight parameter from the dynamic data. The extracted validation flight parameter corresponds to the extracted ATC flight parameter.

At 314, the ATC message validation system 202 receives a traffic ATC message via the ATC communication channel at a communication system 208 of the aircraft 5. The traffic ATC message is a communication from ATC 216 to a traffic aircraft 220a, 220b, 220b. In at least one embodiment, the traffic ATC message is associated with a traffic aircraft 220a, 220b, 220c that is preparing to land at the airport. In at least one embodiment, the traffic ATC message is associated with a traffic aircraft 220a, 220b, 220c that is preparing to take-off from the airport.

At 316, the traffic ATC message is transcribed to generate a traffic ATC text message. The traffic ATC message received at the aircraft 5 is a traffic ATC voice message. The transcription engine 210 transcribes the traffic ATC voice message to generate the traffic ATC text message.

At 318, the ATC message validation system 202 extracts a validation flight parameter from the traffic ATC message. In at least one embodiment, the ATC message validation system 202 extracts the validation flight parameter from the traffic ATC text message. The extracted validation flight parameter corresponds to the extracted ATC flight parameter.

The traffic ATC message is addressed to a traffic aircraft 220a, 220b, 220c and includes traffic flight parameters associated with the traffic aircraft 220a, 220b, 220c landing at or taking-off from the airport. The traffic flight parameters are used by the ATC message validation system 202 as validation flight parameters. Examples of the traffic flight parameters (also referred to as validation flight parameters) include, but are not limited to, an aircraft landing parameter, an aircraft departure parameter, an aircraft traffic parameter, a ground traffic parameter, a runway identifier parameter, an assigned flight level parameter, a runway taxiway identifier parameter, a frequency parameter, a hold short point parameter, and a heading change parameter.

At 320, the ATC message validation system 202 determines whether the ATC flight parameter matches the validation parameters. In at least one embodiment, the ATC message validation system 202 determines whether the ATC flight parameter matches the validation parameter associated with the dynamic data source. In at least one embodiment, the ATC message validation system 202 determines whether the ATC flight parameter matches the validation parameter associated with the traffic ATC message. In at least one embodiment, the ATC message validation system 202 determines whether the ATC flight parameter matches both the validation parameter associated with the dynamic data source and the validation parameter associated with the traffic ATC message.

If the ATC message validation system 202 determines that the ATC flight parameter matches the validation flight parameter(s), the ATC message validation system 202 determines the ATC flight parameter to be valid and provides the ATC flight parameter to the flight control system (FCS) 21 at 322. If the ATC message validation system 202 determines that the ATC flight parameter does not match at least one of the validation flight parameters, the ATC message validation system 202 determines the ATC flight parameter to be invalid and generates a flight parameter mismatch indication for display on a display device 212 of the aircraft 5 at 324.

In at least one embodiment, if the ATC message validation system 202 determines that the ATC flight parameter matches the validation flight parameter(s), the ATC message validation system 202 generates a prompt for display on the display device 212. Upon activation of the prompt via a vehicle input device 214 of the aircraft 5, the ATC message validation system 202 provides the ATC flight parameter to the FCS 21 to enable the FCS 21 to actuate at least one aircraft system in accordance with the first ATC flight parameter.

Each ATC message received at the aircraft 5 includes a time stamp. In at least one embodiment, when the ATC message validation system 202 receives multiple ATC messages that include the same ATC flight parameter, the ATC message validation system 202 identifies the time stamp associated with each of the ATC messages and selects the ATC message with the more recent time stamp for validation.

Each dynamic data received at the aircraft 5 includes a time stamp. In at least one embodiment, when the ATC message validation system 202 receives multiple dynamic data that include the same validation flight parameter, the ATC message validation system 202 identifies the time stamp associated with each of the dynamic data and selects the dynamic data with the more recent time stamp for use in the ATC flight parameter validation process.

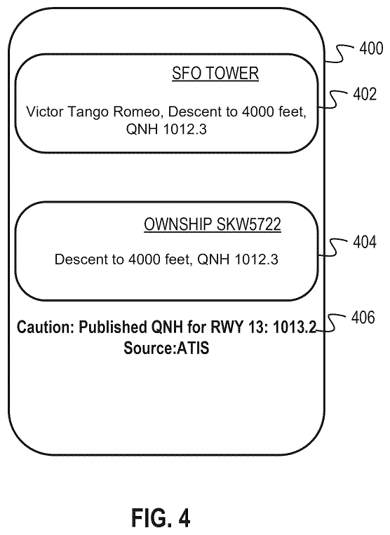

Referring to FIG. 4, an exemplary ATC message validation display 400 in accordance with at least one embodiment is shown. The communication system 208 of an aircraft 5 is tuned to the ATC communication channel. The ATC validation system 202 received an ATC message 402 via the ATC communication channel. The ATC message 402 is a broadcast ATC message. ATC 216 is identified as San Francisco Internation Airport (SFO) Tower. The ATC message 402 is “Descent to 4000 ft, QNH 1012.3.”

The aircraft 5 acknowledged the broadcast ATC message as being relevant to the aircraft 5 in an acknowledgement entry 404. The aircraft identifier of the aircraft 5 is SKW5722. The ATC message validation system 202 extracted an ATC flight parameter from the ATC message. The extracted ATC flight parameter is a QNH parameter of 1012.3.

The ATC message validation system received dynamic data from a dynamic data source. The dynamic data source is ATIS. The dynamic data is the QNH for runway 13 (RWY13) is 1013.2. The ATC message validation system 202 extracted a validation flight parameter from the dynamic data that corresponded to the ATC flight parameter. The extracted validation flight parameter is a QNH parameter of 1013.2.

The ATC message validation system 202 determined that the QNH parameter of 1012.3 (ATC flight parameter) received in the ATC message 402 did not match the QNH parameter of 1013.2 (validation flight parameter) received from the dynamic data source and determined the QNH parameter of 1012.2 received in the ATC message 402 to be invalid. The ATC message validation system 202 generated a flight parameter mismatch indication 406. The flight parameter mismatch indication 406 is “Caution: Published QNH for RWY 13:1013.2)” The dynamic data source of the published QNH in the flight parameter mismatch indication 406 is identified as ATIS.

The use of the ATC message validation system 202 ensures the integrity of ATC clearances received in ATC messages prior to the consumption of ATC flight parameters associated with the ATC clearances received in the ATC messages by cross-checking the ATC flight parameters against validation flight parameters received in dynamic data from dynamic data sources 218 and/or validation flight parameters received in traffic ATC messages. The use of ATC flight parameters received in the most recent ATC message and the use of the most recent validation flight parameters to perform the cross-checking enables proper ATC flight parameter validation. The ATC message validation system 202 enables the capturing of deviations of the ATC flight parameters with respect to the validation flight parameters.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An air traffic control (ATC) message validation system comprising:
at least one processor; and
at least one memory communicatively coupled to the at least one processor, the at least one memory comprising instructions that, upon execution by the at least one processor, cause the at least one processor to:
receive a first ATC message comprising a first ATC flight parameter from ATC via an ATC communication channel at a communication system of an aircraft;
receive first dynamic data comprising a first validation flight parameter from a dynamic data source via the communication system of the aircraft;
determine whether the first ATC flight parameter matches the first validation flight parameter; and
generate a flight parameter mismatch indication associated with the first ATC flight parameter for display on a display device of the aircraft based on the determination.

2. The system of claim 1, wherein the first ATC message comprises an aircraft specific ATC message.

3. The system of claim 2, wherein the first ATC flight parameter comprises one of, an aircraft landing parameter, an aircraft departure parameter, an aircraft traffic parameter, a ground traffic parameter, a runway identifier parameter, an assigned flight level parameter, a runway taxiway identifier parameter, a frequency parameter, a hold short point parameter, and a heading change parameter.

4. The system of claim 1, wherein the first ATC message comprises a broadcast ATC message.

5. The system of claim 4, wherein the first ATC flight parameter comprises one of an external environment parameter and a mean sea level pressure (QNH) parameter.

6. The system of claim 1, wherein, the dynamic data source comprises at least one of an Automatic Dependent Surveillance-Broadcast (ADS-B), a Traffic Alert and Collision Avoidance System (TCAS), a Notice to Airmen (NOTAM), radiotelephony (RTF), Controller Pilot Data Link Communications (CPDLC), an Internet-linked device, and an Automatic Terminal Information Service (ATIS).

7. The system of claim 1, wherein the at least one memory comprises further instructions that, upon execution by the at least one processor, cause the at least one processor to:
transcribe the first ATC message to generate a first ATC text message using a transcription engine; and
extract the first ATC flight parameter from the first ATC text message.

8. The system of claim 1, wherein the at least one memory comprises further instructions that, upon execution by the at least one processor, cause the at least one processor to:
receive a first traffic ATC message comprising a second validation flight parameter via the ATC communication channel at the communication system of the aircraft;
determine whether the first ATC flight parameter matches the second validation flight parameter; and
generate the flight parameter mismatch indication associated with the first ATC flight parameter for display on the display device of the aircraft based on the determination.

9. The system of claim 1, wherein the at least one memory comprises further instructions that, upon execution by the at least one processor, cause the at least one processor to:
transcribe the first traffic ATC message to generate a first traffic ATC text message using a transcription engine; and
extract the second validation flight parameter from the first traffic ATC text message.

10. The system of claim 1, wherein, the at least one memory comprises further instructions that, upon execution by the at least one processor, cause the at least one processor to:
identify a first time-stamp associated with the first ATC message;
receive a second ATC message comprising a second ATC flight parameter from ATC via an ATC communication channel at a communication system of an aircraft;
identify a second time-stamp associated with the second ATC message; and
upon a determination that the first time-stamp precedes the second time-stamp determine whether the first ATC flight parameter matches the first validation flight parameter.

11. The system of claim 1, wherein the at least one memory comprises further instructions that, upon execution by the at least one processor, cause the at least one processor to:
identify a third time-stamp associated with the first dynamic data;
receive second dynamic data comprising a third validation flight parameter from the dynamic data source via the communication system of the aircraft;
identify a fourth time-stamp associated with the second dynamic data; and
upon a determination that the third time-stamp precedes the fourth time-stamp determine whether the first ATC flight parameter matches the first validation flight parameter.

12. The system of claim 1, wherein the at least one memory comprises further instructions that, upon execution by the at least one processor, cause the at least one processor to:
based upon a determination that the first ATC flight parameter does match the first validation flight parameter, generate a prompt for display on the display device; and
upon activation of the prompt via a vehicle input device, provide the first ATC flight parameter to a flight control system (FCS) of the aircraft to enable the FCS to actuate at least one aircraft system in accordance with the first ATC flight parameter.

13. A method of validating air traffic control (ATC) messages, comprising:
receiving a first ATC message comprising a first ATC flight parameter from ATC via an ATC communication channel at a communication system of an aircraft;
receiving first dynamic data comprising a first validation flight parameter from a dynamic data source via the communication system of the aircraft;
determining whether the first ATC flight parameter matches the first validation flight parameter; and
generating a flight parameter mismatch indication associated with the first ATC flight parameter for display on a display device of the aircraft based on the determination.

14. The method of claim 13, wherein the first ATC message comprises an aircraft specific ATC message and the first ATC flight parameter comprises one of, an aircraft landing parameter, an aircraft departure parameter, an aircraft traffic parameter, a ground traffic parameter, a runway identifier parameter, an assigned flight level parameter, a runway taxiway identifier parameter, a frequency parameter, a hold short point parameter, and a heading change parameter.

15. The method of claim 13, wherein the first ATC message comprises a broadcast ATC message and the first ATC flight parameter comprises one of an external environment parameter and a mean sea level pressure (QNH) parameter.

16. The method of claim 13, wherein, the dynamic data source comprises at least one of an Automatic Dependent Surveillance-Broadcast (ADS-B), a Traffic Alert and Collision Avoidance System (TCAS), a Notice to Airmen (NOTAM), radiotelephony (RTF), Controller Pilot Data Link Communications (CPDLC), an Internet-linked device, and an Automatic Terminal Information Service (ATIS).

17. The method of claim 13, further comprising:
transcribing the first ATC message to generate a first ATC text message using a transcription engine; and
extracting the first ATC flight parameter from the first ATC text message.

18. The method of claim 13, further comprising:
receiving a first traffic ATC message comprising a second validation flight parameter via the ATC communication channel at the communication system of the aircraft;
determining whether the first ATC flight parameter matches the second validation flight parameter; and
generating the flight parameter mismatch indication associated with the first ATC flight parameter for display on the display device of the aircraft based on the determination.

19. The method of claim 18, further comprising:
transcribing the first traffic ATC message to generate a first traffic ATC text message using a transcription engine; and
extracting the second validation flight parameter from the first traffic ATC text message.

20. At least one non-transitory machine-readable storage medium that stores instructions executable by at least one processor, the instructions configurable to cause the at least one processor to perform operations comprising:
receiving a first ATC message comprising a first ATC flight parameter from ATC via an ATC communication channel at a communication system of an aircraft;
receiving first dynamic data comprising a first validation flight parameter from a dynamic data source via the communication system of the aircraft;
determining whether the first ATC flight parameter matches the first validation flight parameter; and
generating a flight parameter mismatch indication associated with the first ATC flight parameter for display on a display device of the aircraft based on the determination.
